(19) United States
(12) Patent Application Publication
(10) Pub. No.: US 2023/0186118 A1
(43) Pub. Date: Jun. 15, 2023

(54) COMPUTER-READABLE RECORDING MEDIUM STORING ACCURACY ESTIMATION PROGRAM, DEVICE, AND METHOD

(71) Applicant: FUJITSU LIMITED, Kawasaki-shi (JP)

(72) Inventors: Tomohiro HAYASE, Kawasaki (JP); TAKASHI KATOH, Kawasaki (JP); Suguru YASUTOMI, Kawasaki (JP); Kento UEMURA, Kawasaki (JP)

(73) Assignee: FUJITSU LIMITED, Kawasaki-shi (JP)

(21) Appl. No.: 18/157,639

(22) Filed: Jan. 20, 2023

Related U.S. Application Data
(63) Continuation of application No. PCT/JP2020/029306, filed on Jul. 30, 2020.

(51) Int. Cl. G06N 5/022

(52) U.S. Cl. CPC G06N 5/022

(57) ABSTRACT

A program for causing a computer to execute processing including: acquiring a plurality of datasets, each of which includes data values associated with a label, the data values having properties different for each dataset; calculating an index indicating a degree of a difference between first and second datasets by using a data value in the second dataset; calculating accuracy of a prediction result for the second dataset, predicted by a prediction model trained using the first dataset; specifying a relationship between the index and the accuracy of the prediction result from the prediction model, based on the index and the accuracy calculated for each of a plurality of combinations of the first and second datasets; and estimating accuracy of the prediction result from the prediction model for a third dataset including data values without labels based on the specified relationship and the index between the first and third datasets.

### CROSS-REFERENCE TO RELATED APPLICATION

This application is a continuation application of International Application PCT/JP2020/029306 filed on Jul. 30, 2020 and designated the U.S., the entire contents of which are incorporated herein by reference.

### FIELD

The disclosed technology relates to an accuracy estimation program, an accuracy estimation device, and an accuracy estimation method.

### BACKGROUND

As performance verification of a learned model (may be referred to as “a trained model”) learned through machine learning, for example, performance verification through cross validation is performed. In cross validation, a dataset with a label indicating a correct answer is divided into learning data, verification data, and test data. Then, a model is designed while verifying a model learned with the learning data using the verification data, and verification of final accuracy is performed using the test data.

“Cross-validation: evaluating estimator performance”, [online], [retrieved on Jun. 8, 2020], Internet <URL: https://scikit-learn.org/stable/modules/cross validation.html> and Ron Kohavi, “A Study of Cross-Validation and Bootstrap for Accuracy Estimation and Model Selection”, International Joint Conference on Artificial Intelligence, 1995 are disclosed as related art.

It is considered to estimate accuracy of a learned model for real data in a real environment where a learned model is used. In this case, since there is a case where properties of data used to learn the learned model and the real data change due to an environment change, reliability of verification based on the data at the time of learning is low as the accuracy for the real data. For example, it is not found how accurate the learned model can be for the real environment. Therefore, it is considered to perform verification by preparing labeled real data. However, there is a problem in that large work cost is needed to label the real data.

As one aspect, an object of the disclosed technology is to estimate accuracy of a learned model for unlabeled real data.

### SUMMARY

According to an aspect of the embodiments, there is provided a non-transitory computer-readable recording medium storing an accuracy estimation program for causing a computer to execute processing. In an example, the processing includes: acquiring, in a processor circuit of the computer, a plurality of datasets, each of which includes a plurality of pieces of data in which each data value is associated with a label, the data values having properties different for each dataset; calculating, in the processor circuit of the computer, an index that indicates a degree of a difference between a first dataset included in the plurality of datasets and a second dataset included in the plurality of datasets by using a data value included in the second dataset; calculating, in the processor circuit of the computer, accuracy of a prediction result for the second dataset, predicted by a prediction model trained by using the first dataset; in response to obtaining the calculated index and the calculated accuracy, specifying, in the processor circuit of the computer, a relationship between the index and the accuracy of the prediction result by the prediction model, based on the index and the accuracy calculated for each of a plurality of combinations of the first dataset and the second dataset; and in response to the specifying of the relationship, estimating, in the processor circuit of the computer, accuracy of the prediction result by the prediction model for a third dataset that includes a plurality of data values that are not associated with labels based on the index between the first dataset and the third dataset and the specified relationship.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram of an accuracy estimation device;

FIG. 2 is a diagram for explaining learning of a prediction model;

FIG. 3 is a diagram for explaining calculation of an index;

FIG. 4 is a diagram for explaining maximization of a classification error;

FIG. 5 is a diagram for explaining the maximization of the classification error;

FIG. 6 is a diagram for explaining calculation of accuracy;

FIG. 7 is a diagram for explaining specification of an index-accuracy curve;

FIG. 8 is a diagram for explaining estimation of accuracy for an actual dataset;

FIG. 9 is a block diagram illustrating a schematic configuration of a computer that functions as the accuracy estimation device;

FIG. 10 is a flowchart illustrating an example of specification processing;

FIG. 11 is a flowchart illustrating an example of estimation processing; and

FIG. 12 is a diagram for explaining early stop of an iterative algorithm when a maximum classification error is calculated.

### DESCRIPTION OF EMBODIMENTS

Hereinafter, an example of an embodiment according to the disclosed technology will be described with reference to the drawings.

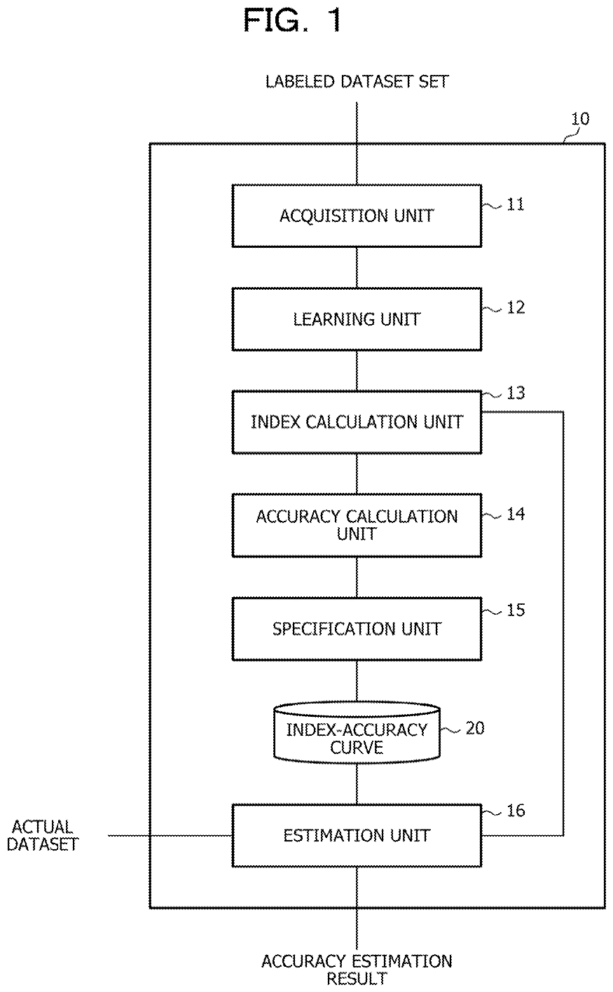

As illustrated in FIG. 1, an accuracy estimation device 10 specifies a relationship between an index that indicates a difference between datasets and accuracy of a prediction result of a model with respect to the dataset, using an input labeled dataset set. Then, the accuracy estimation device 10 estimates accuracy of a prediction result of a model for an input actual dataset, using the specified relationship.

As illustrated in FIG. 1, the accuracy estimation device 10 functionally includes an acquisition unit 11, a learning unit 12, an index calculation unit 13, an accuracy calculation unit 14, a specification unit 15, and an estimation unit 16. Furthermore, in a predetermined storage region of the accuracy estimation device 10, an index-accuracy curve 20 is stored.

The acquisition unit 11 acquires a labeled dataset set input to the accuracy estimation device 10 and transfers the dataset set to the learning unit 12.

The labeled dataset set includes a plurality of labeled datasets. Each labeled dataset includes a plurality of pieces of data in which a data value is associated with a label representing a correct answer of a target indicated by the data value. For example, in a case where the model is a recognition model that recognizes a number from an image, the dataset includes a plurality of (for example, 1,000) image sets with which any one of labels of zero to nine is associated. Furthermore, for example, in a case where the model is an identification model that identifies whether an input image is a dog image or a cat image, the dataset includes a plurality of image sets with which a label indicating a dog or a cat is associated. Furthermore, for example, in a case where the model is a detection model that detects a person from an image, the dataset includes a plurality of image sets with which a label indicating whether or not a person exists is associated.

Furthermore, regarding each of the plurality of datasets included in the labeled dataset set, a property of the data value included in each dataset differs for each dataset. For example, by making an environment such as a data value acquisition process or generation process be different, it is possible to prepare datasets respectively having different properties of the data values. For example, a dataset prepared for the recognition model that recognizes a number as described above can be assumed to be a dataset of a white and black image of a handwritten number that is simply written, a dataset of a colored image of the white and black image of the handwritten number, or the like. Furthermore, for example, a dataset of an image obtained by imaging a number portion in a real environment such as a house address nameplate, a dataset of a synthesized image created by computer graphics or the like, a dataset of an image of handwritten numbers decorated or processed as hollow characters or the like can be used.

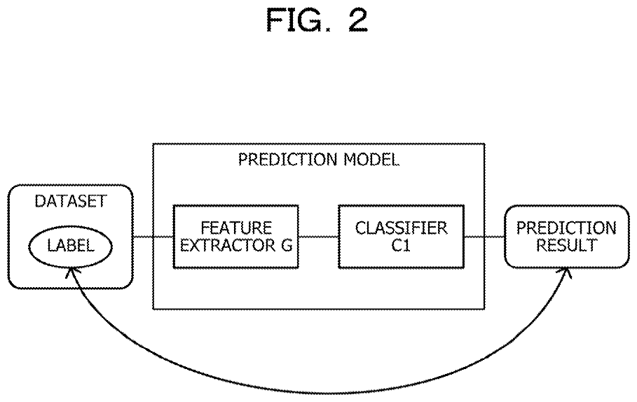

The learning unit 12 generates a model by performing learning using the labeled dataset set transferred from the acquisition unit 11. The model outputs any prediction result for real data, as the recognition model, the identification model, the detection model, or the like described above. Hereinafter, the model is also referred to as a “prediction model”. As illustrated in FIG. 2, the prediction model includes a feature extractor G that extracts a feature from a data value and a classifier C1 that outputs a prediction result indicating which label is associated with the data value by classifying the feature extracted by the feature extractor G.

For example, the learning unit 12 learns a parameter (weight) in the prediction model, using each labeled dataset included in the labeled dataset set. More specifically, as illustrated in FIG. 2, the learning unit 12 learns the parameter of each of the feature extractor G and the classifier C1, so that the label included in the dataset is associated with the prediction result by the prediction model for the data value included in the dataset. The learning unit 12 transfers the prediction model learned for each labeled dataset and the labeled dataset set transferred from the acquisition unit 11 to the index calculation unit 13. It is noted that the word “learning” may be referred to as “training”. For instance, the learning of the parameter (weight) in the prediction model may be referred to as training the parameter (weight) in the prediction model, training the prediction model, and the like.

The index calculation unit 13 calculates an index indicating a degree of a difference between a first dataset included in the labeled dataset set transferred from the learning unit 12 and a second dataset different from the first dataset. The index calculation unit 13 calculates the index using the data value included in the dataset. For example, the index calculation unit 13 calculates the index without using the label. For example, the index calculation unit 13 calculates the index, using a prediction result by a prediction model learned by using the first dataset, with respect to a data value included in the second dataset. By only simply comparing the data values between the datasets, it is difficult to distinguish whether properties of the datasets are difficult or whether the difference is caused by a difference in the data itself although the properties are common. The index calculation unit 13 calculates an index indicating the difference between the dataset properties, by using the prediction result of the prediction model.

Hereinafter, the first dataset is referred to as a “dataset DS”, and the second dataset is referred to as a “dataset DT”. The index calculation unit 13 assumes each combination of the two datasets included in the labeled dataset set as a pair of the datasets DS and DT and calculates an index for each of all pairs.

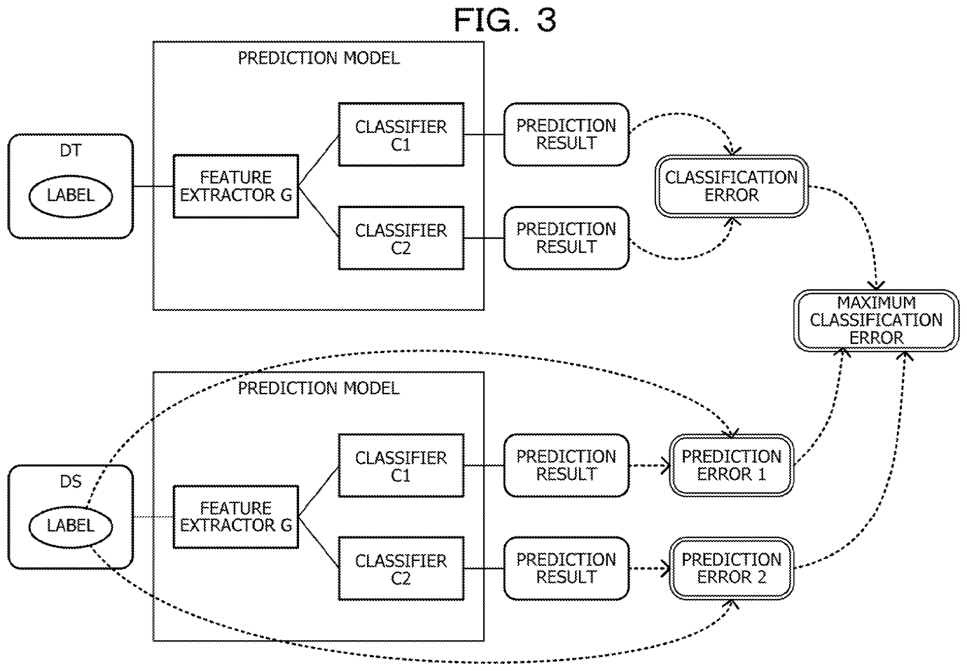

More specifically, the index calculation unit 13 generates a plurality of classifiers having at least different parameters, as a classifier of a prediction model learned by using the dataset DS. Then, as illustrated in the upper part of FIG. 3, the index calculation unit 13 calculates a classification error that is a difference between prediction results of the plurality of classifiers with respect to the dataset DT as an index.

For example, the index calculation unit 13 generates a classifier obtained by initializing the parameter of the classifier C1 of the prediction model learned using the dataset DS as a classifier C2. Then, the index calculation unit 13 calculates a classification error d (C1, C2) between a prediction result by the classifier C1 and a prediction result by the classifier C2, for the dataset DT, for example, according to the following formula (1).

$$\begin{matrix}[ Expression 1 ] & \\ d ( C 1 , C 2 ) = \frac{1}{\vert DT \vert} {\sum }_{xt ∈ DT} \frac{1}{K} {\sum }_{1}^{K} \vert C 1 {( G ( x t ) )}_{k} - C 2 {( G ( x t ) )}_{k} \vert & ( 1 )\end{matrix}$$

Here, |DT| is the number of pieces of data included in the dataset DT, xt is a data value of the data included in the dataset DT, K is the number of types of labels, and G (xt) is a feature amount of the data value xt extracted by the feature extractor G. Furthermore, Ci (X)ₖ is a prediction result for a label k by a classifier Ci (i is one or two) based on a feature amount X. A classification error indicated in the formula (1) is an index that can be calculated without using the label of the dataset DT.

Furthermore, the index calculation unit 13 calculates a maximized classification error (maximum classification error, MCD, maximum classifier discrepancy) while optimizing the classifiers C1 and C2 as an index using by the specification unit 15 to be described later. For example, the index calculation unit 13 minimizes a loss function Loss indicated by the following formula (2).

Loss((xs,ys),xt)=CrossEntropyLoss(C1(G(xs)),ys)+CrossEntropyLoss(C2(G(xs)),ys)−MeanL1Norm(C1(G(xt))−C2(G(xt))) (2)

Here, xs is a data value of data included in the dataset DS, and ys is a label associated with the data value xs. A first term of the formula (2) is an error of a prediction result for the dataset DS by a prediction model of which a classifier is the classifier C1, and corresponds to a prediction error 1 illustrated in the lower part of FIG. 3. A second term is an error of a prediction result for the dataset DS by a prediction model of which a classifier is the classifier C2, and corresponds to a prediction error 2 illustrated in the lower part of FIG. 3. A third term is a classification error for the dataset DT and, for example, corresponds to the formula (1) described above.

The index calculation unit 13 optimizes parameters of the classifiers C1 and C2 so as to minimize the loss function Loss indicated by the formula (2) and sets a third term when the loss function Loss is minimized as the maximum classification error. Note that, when the loss function Loss is minimized, the parameter of the feature extractor G is assumed to be fixed.

Here, a reason for maximizing the classification error will be described. Here, for simple explanation, a case will be described where a label is a binary value of zero and one and the feature amount extracted by the feature extractor G can be two-dimensionally expressed.

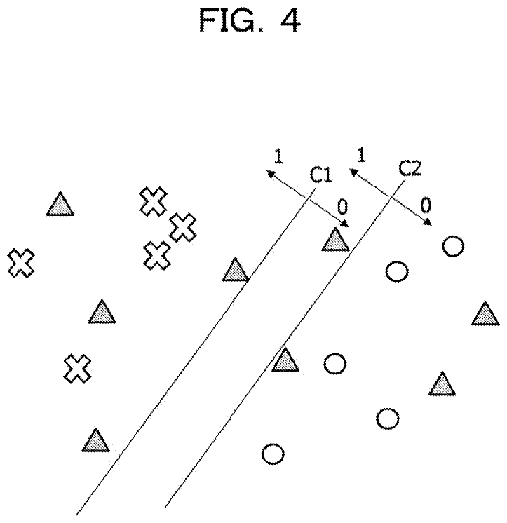

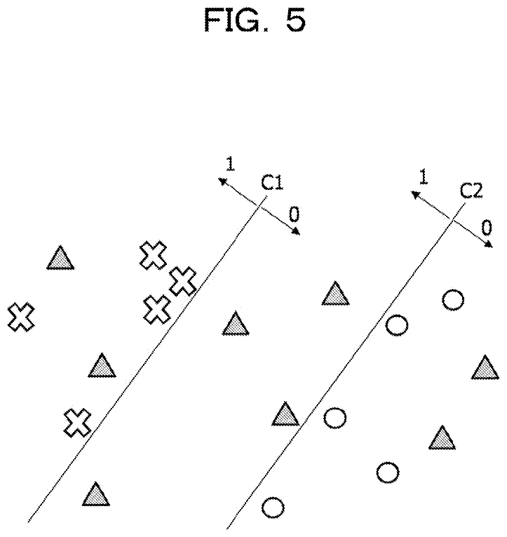

In FIGS. 4 and 5, an example is illustrated in which a classification boundary by the classifier C1, a classification boundary by the classifier C2, and each feature amount extracted from the data value included in each dataset are two-dimensionally projected. In FIGS. 4 and 5, a circle (◯) indicates a feature amount of data, with which a label 0 is associated, included in the dataset DS, and a cross (x) indicates a feature amount of data, with which a label 1 is associated, included in the dataset DS. Furthermore, a triangle (Δ) indicates a feature amount of data included in the dataset DT.

In a state where the classifiers C1 and C2 are optimized and ◯ and x are appropriately determined for both of the classification boundaries of the classifiers C1 and C2, a ratio of Δ for which determinations by the classifiers C1 and C2 are different, among Δ, for example, a ratio at which the classifier hesitates in determination is considered as the classification error. In the example in FIG. 4, the classification error is 1/8, in the example in FIG. 5, the classification error is 4/8. The ratio at which the classifier hesitates to determine the feature amount extracted from the data of the dataset DT can be regarded as representing incompatibility of the feature extractor G learned using the dataset DS with the dataset DT. For example, it can be said that, as the classification error is larger, the dataset DT is a dataset having a different property from the dataset DS, for the prediction model. Therefore, in order to accurately specify a hesitation degree of the classifier with respect to the dataset DT, the classification error is maximized.

FIG. 4 is an example in which the classification error is not maximized, and FIG. 5 is an example in which the classification error is maximized. When the example in FIG. 4 is compared with the example in FIG. 5, the example in FIG. 5 can specify A indicating that the classifier hesitates the determination without omission as possible. For example, by maximizing the classification error, it is possible to calculate an index with a higher quality as the index indicating the difference between the datasets DS and DT.

The index calculation unit 13 transfers the maximum classification error calculated for each pair of the datasets DS and DT to the specification unit 15 and transfers the labeled dataset set to the accuracy calculation unit 14.

Furthermore, the index calculation unit 13 calculates an index indicating a difference between the dataset DS used to learn the prediction model and the actual dataset, in response to an instruction from the estimation unit 16 to be described later. For example, the index calculation unit 13 calculates a classification error as an index, by replacing the dataset DT in the formula (1) described above with the actual dataset. The index calculation unit 13 transfers an index for the calculated actual dataset to the estimation unit 16. Note that the “actual dataset” is an example of a “third dataset” according to the disclosed technology.

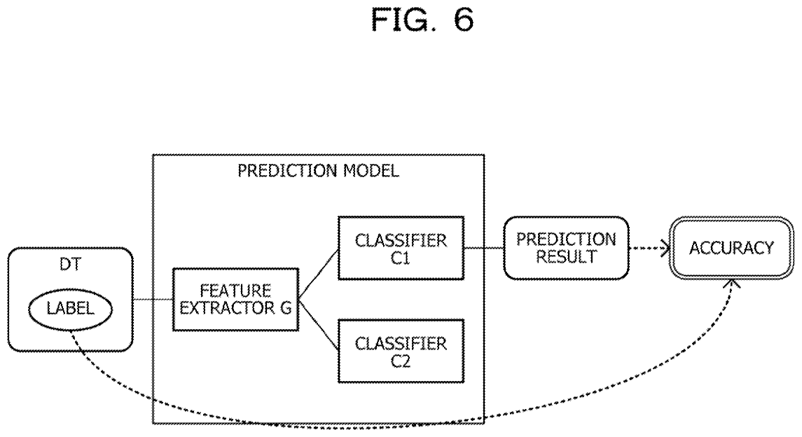

The accuracy calculation unit 14 calculates accuracy of the prediction result for the dataset DT, predicted by the prediction model learned using the dataset DS. For example, as illustrated in FIG. 6, the accuracy calculation unit 14 inputs the dataset DT into the prediction model including the feature extractor G and the classifier C1. Then, the accuracy calculation unit 14 calculates accuracy represented, for example, by a correct answer rate or the like, based on the prediction result obtained from the prediction model and the label included in the dataset DT. The accuracy calculation unit 14 also calculates accuracy for each dataset DT of which the index is calculated by the index calculation unit 13. The index calculation unit 13 transfers the accuracy calculated for each dataset DT to the specification unit 15.

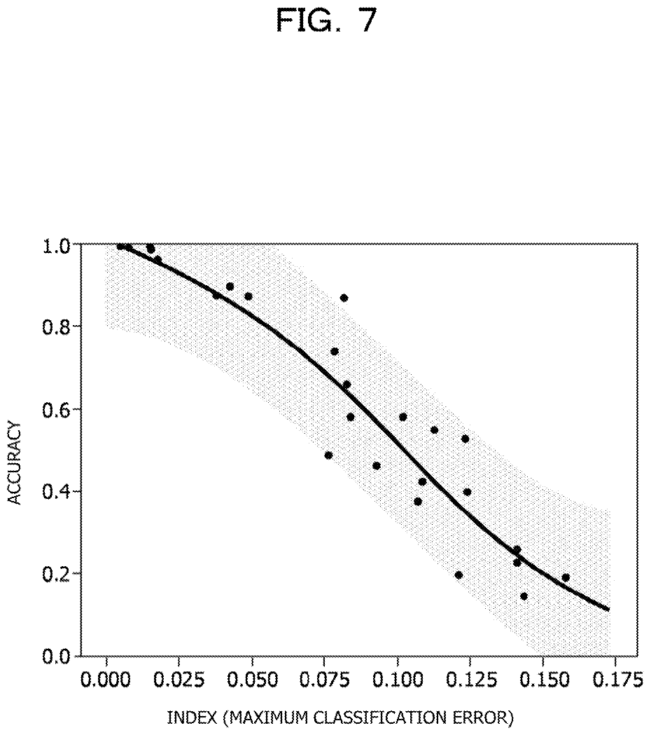

The specification unit 15 specifies a relationship between the difference between the datasets and the accuracy of the prediction result by the prediction model, based on the index and the accuracy calculated for each of the plurality of combinations of the datasets DS and DT. For example, as illustrated in FIG. 7, the specification unit 15 plots points (black circle in FIG. 7) corresponding to the maximum classification error that is the index calculated for each pair of the datasets DS and DT and the accuracy, in a space where the horizontal axis indicates an index and the vertical axis indicates accuracy. The specification unit 15 obtains a regression curve (solid curve in FIG. 7) indicating an estimated value, for example, obtained by Bayesian estimation or the like, based on the plotted points. Hereinafter, this regression curve is referred to as the “index-accuracy curve 20”.

In the example in FIG. 7, a confidence interval (hatched portion in FIG. 7) that is 95% with respect to the estimated value is illustrated together with the index-accuracy curve 20. As illustrated in FIG. 7, a relationship between an index indicating a difference between datasets and accuracy of a prediction result by the prediction model is a relationship of which accuracy monotonically decreases as the maximum classification error that is the index increases. The specification unit 15 stores information regarding the obtained index-accuracy curve 20 in a predetermined storage region.

The estimation unit 16 estimates accuracy of a prediction result by a prediction model for an actual dataset that includes a plurality of pieces of data in which a label is not associated with a data value, based on the index indicating the difference between the dataset DS and the actual dataset and the index-accuracy curve 20. The actual dataset is a dataset of a data value acquired in a real environment to which the prediction model is applied.

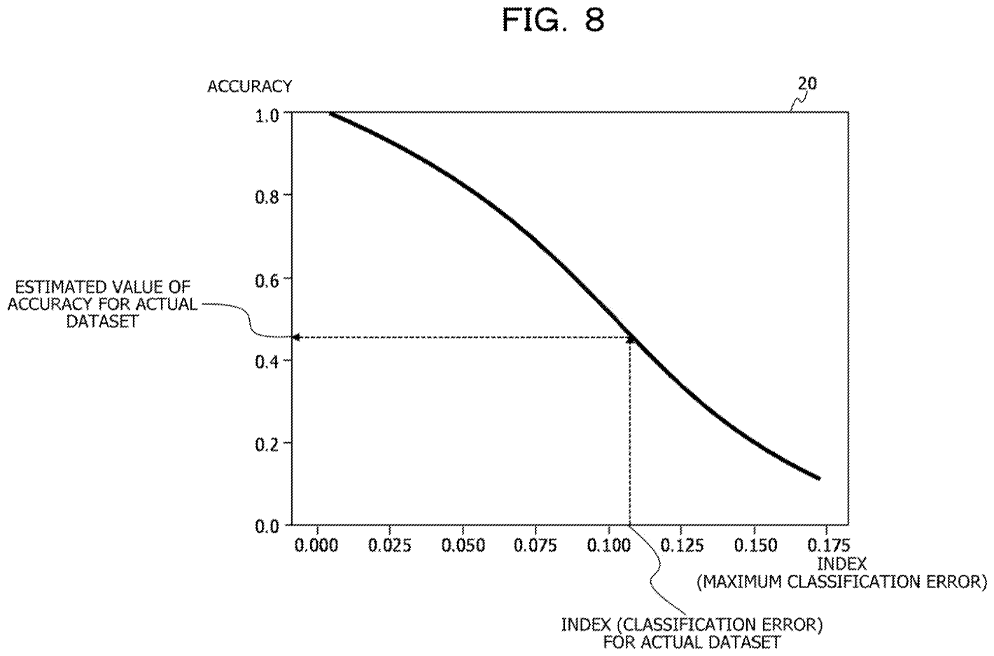

For example, the estimation unit 16 acquires the actual dataset, transfers the actual dataset to the index calculation unit 13, and instructs the index calculation unit 13 to calculate the classification error as an index regarding the actual dataset, and receives the index regarding the actual dataset from the index calculation unit 13. Then, as illustrated in FIG. 8, the estimation unit 16 acquires an estimated value of accuracy corresponding to the index for the actual dataset with reference to the index-accuracy curve 20. The estimation unit 16 outputs the acquired estimated value as an accuracy estimation result.

Note that the parameter of the classifier C1 of the prediction model in the real environment may be a randomly initialized value. Typically, in the prediction model, the feature extractor G is an essential part, and the classifier C1 has a shallow structure, for example, with about one or two layers. Therefore, a difference between the parameter of the classifier C1 in the real environment and the parameter of the classifier C1 when the index-accuracy curve 20 is obtained does not largely affect the estimation of the accuracy.

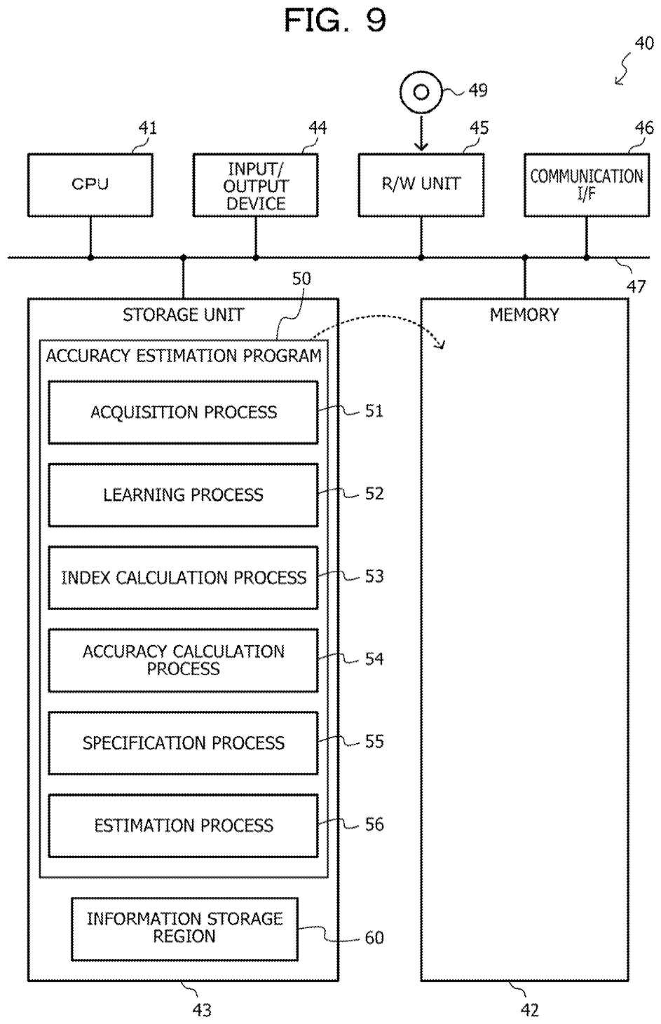

The accuracy estimation device 10 can be implemented by, for example, a computer 40 illustrated in FIG. 9. The computer 40 includes a central processing unit (CPU) 41, a memory 42 as a temporary storage region, and a nonvolatile storage unit 43. Furthermore, the computer 40 includes an input/output device 44 such as an input unit or a display unit, and a read/write (R/W) unit 45 that controls reading and writing of data from/to a storage medium 49. Furthermore, the computer 40 includes a communication interface (I/F) 46 to be connected to a network such as the Internet. The CPU 41, the memory 42, the storage unit 43, the input/output device 44, the R/W unit 45, and the communication I/F 46 are connected to each other via a bus 47.

The storage unit 43 may be implemented by a hard disk drive (HDD), a solid state drive (SSD), a flash memory, or the like. The storage unit 43 as a storage medium stores an accuracy estimation program 50 that causes the computer 40 to function as the accuracy estimation device 10. The accuracy estimation program 50 includes an acquisition process 51, a learning process 52, an index calculation process 53, an accuracy calculation process 54, a specification process 55, and an estimation process 56. Furthermore, the storage unit 43 includes an information storage region 60 that stores information included in the index-accuracy curve 20.

The CPU 41 reads the accuracy estimation program 50 from the storage unit 43, expands the accuracy estimation program 50 in the memory 42, and sequentially executes the processes included in the accuracy estimation program 50. By executing the acquisition process 51, the CPU 41 operates as the acquisition unit 11 illustrated in FIG. 1. Furthermore, the CPU 41 operates as the learning unit 12 illustrated in FIG. 1 by executing the learning process 52. Furthermore, the CPU 41 operates as the index calculation unit 13 illustrated in FIG. 1 by executing the index calculation process 53. Furthermore, the CPU 41 operates as the accuracy calculation unit 14 illustrated in FIG. 1 by executing the accuracy calculation process 54. Furthermore, the CPU 41 operates as the specification unit 15 illustrated in FIG. 1 by executing the specification process 55. Furthermore, the CPU 41 operates as the estimation unit 16 illustrated in FIG. 1 by executing the estimation process 56. Furthermore, the CPU 41 reads the information from the information storage region 60 and expands the index-accuracy curve in the memory 42. As a result, the computer 40 that executes the accuracy estimation program 50 functions as the accuracy estimation device 10. Note that the CPU 41 that executes the program is hardware.

Note that the function implemented by the accuracy estimation program 50 may be implemented, for example, by a semiconductor integrated circuit, more specifically, an application specific integrated circuit (ASIC) or the like.

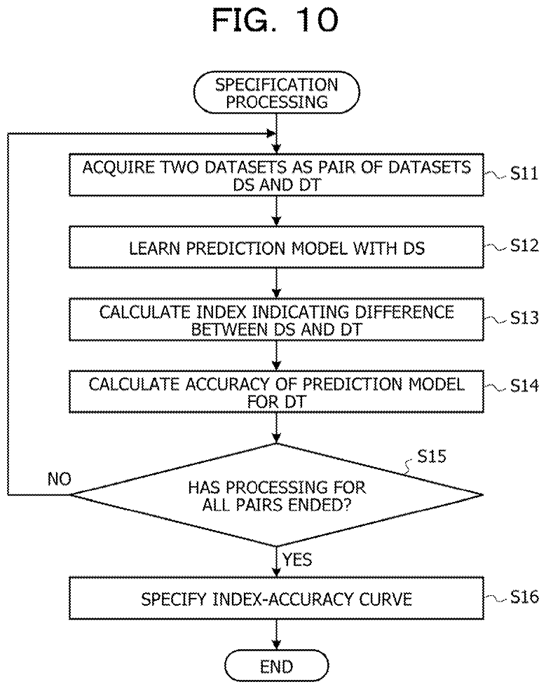

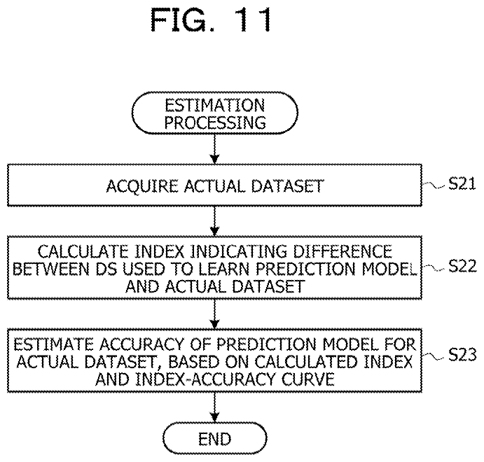

Next, a behavior of the accuracy estimation device 10 according to the present embodiment will be described. When the labeled dataset set is input to the accuracy estimation device 10 and an instruction to specify the index-accuracy curve 20 is issued, the accuracy estimation device 10 executes specification processing illustrated in FIG. 10. Furthermore, when the actual dataset is input to the accuracy estimation device 10 and an instruction to estimate accuracy is issued, the accuracy estimation device 10 executes estimation processing illustrated in FIG. 11. Note that the specification processing and the estimation processing are examples of the accuracy estimation method according to the disclosed technology. Hereinafter, each of the specification processing and the estimation processing will be described in detail.

First, the specification processing will be described with reference to FIG. 10.

In step S11, the acquisition unit 11 selects two datasets from the labeled dataset set input to the accuracy estimation device 10, acquires the datasets as a pair of the datasets DS and DT, and transfers the datasets to the learning unit 12.

Next, in step S12, the learning unit 12 learns the parameter of each of the feature extractor G and the classifier C1 included in the prediction model so that the label included in the dataset DS is associated with the prediction result by the prediction model for the data value included in the dataset DS.

Next, in step S13, the index calculation unit 13 generates a classifier obtained by initializing the parameter of the classifier C1 of the prediction model learned using the dataset DS as the classifier C2. Then, the index calculation unit 13 calculates a classification error between the prediction result by the classifier C1 and the prediction result by the classifier C2 for the dataset DT. Moreover, the index calculation unit 13 calculates a maximum classification error obtained by maximizing the classification error while optimizing the classifiers C1 and C2.

Next, in step S14, the accuracy calculation unit 14 inputs the dataset DT to the prediction model and calculates accuracy represented, for example, by a correct answer rate or the like, based on the prediction result obtained from the prediction model and the label included in the dataset DT. The accuracy calculation unit 14 temporarily stores the calculated accuracy in a predetermined storage region, together with the index calculated in step S13 described above.

Next, in step S15, the acquisition unit 11 determines whether or not the processing in steps S11 to S14 ends, for all the pairs of datasets included in the labeled dataset set. In a case where there is an unprocessed pair, the processing returns to step S11, and in a case where the processing on all the pairs has been completed, the processing proceeds to step S16.

In step S16, the specification unit 15 plots points corresponding to the maximum classification error that is the calculated index for each pair of the datasets DS and DT and the accuracy that are temporarily stored in the predetermined storage region, in the space where the horizontal axis indicates an index and the vertical axis indicates accuracy. Then, the specification unit 15 specifies a regression curve indicating the estimated value, for example, obtained by Bayesian estimation or the like as the index-accuracy curve 20, based on the plotted points. The specification unit 15 stores information regarding the specified index-accuracy curve 20 in the predetermined storage region and ends the specification processing.

Next, the estimation processing will be described with reference to FIG. 11.

In step S21, the estimation unit 16 acquires an actual dataset and transfers the actual dataset to the index calculation unit 13, and instructs the index calculation unit 13 to calculate a classification error as an index regarding the actual dataset.

Next, in step S22, the index calculation unit 13 calculates a classification error as an index indicating a difference between the dataset DS used to learn the prediction model and the actual dataset and transfers the calculated index regarding the actual dataset to the estimation unit 16.

Next, in step S23, the estimation unit 16 acquires an estimated value of the accuracy corresponding to the index regarding the actual dataset with reference to the index-accuracy curve 20 and outputs the acquired estimated value as the accuracy estimation result. Then, the estimation processing ends.

As described above, the accuracy estimation device according to the present embodiment acquires the plurality of datasets of which the property of the data value is different for each dataset, and calculates the index indicating the degree of the difference between the datasets, for each pair of the datasets DS and DT. As an index, the maximum classification error is calculated that is obtained by maximizing the classification error indicating the difference between the respective prediction results of the plurality of classifiers for the dataset DT while optimizing the plurality of classifiers. Furthermore, the accuracy estimation device calculates the accuracy of the prediction result for the dataset DT, predicted by the prediction model learned using the dataset DS. Then, the accuracy estimation device specifies the relationship between the difference between the datasets and the accuracy of the prediction result by the prediction model, based on the index and the accuracy calculated for each of the plurality of pairs of the datasets DS and DT. Moreover, the accuracy estimation device estimates the accuracy of the prediction result by the prediction model learned using the dataset DS, for the actual dataset, based on the classification error between the dataset DS and the actual dataset and the specified relationship. As a result, the accuracy of the learned model for the real data with no label can be estimated.

Furthermore, the index-accuracy curve is specified as the relationship between the difference between the datasets and the accuracy of the prediction result by the prediction model and is used to estimate the accuracy of the actual dataset. As a result, it is possible to quantitatively estimate how much the accuracy of the prediction model is lowered, with respect to a change in the property between the datasets caused by the difference between the environment at the time of prediction model learning and the real environment.

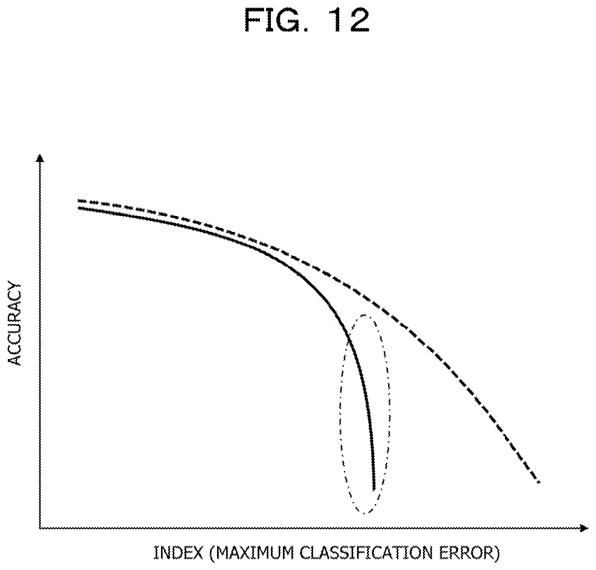

Note that, in the embodiment described above, the maximum classification error can be calculated by minimizing the loss function Loss with the iterative algorithm. The number of iterations of this iterative algorithm may be limited to stop the iterative algorithm early. As indicated by a dashed line in FIG. 12, regarding the relationship between the maximum classification error and the accuracy, it is desirable that the accuracy does not rapidly fluctuates with respect to a fluctuation of the maximum classification error. However, when the number of iterations of the iterative algorithm when the maximum classification error is calculated increases, the maximum classification error may be approximately the same for all the datasets. In this case, regarding the relationship between the maximum classification error and the accuracy, as indicated by a solid line in FIG. 12, although the fluctuation of the maximum classification error is small in a part where the maximum classification error is large, the accuracy is rapidly lowered (alternate long and short dash line in FIG. 12).

With such an index-accuracy curve, the estimated value of the accuracy largely differs in the part where the maximum classification error is large, and it is not possible to stably estimate the accuracy. Therefore, the iterative algorithm is stopped early so that the index-accuracy curve indicates a desired fluctuation as indicated by the dashed line in FIG. 12. It is sufficient to specify and set the number of iterations in a case of early stopping through experiments or the like in advance so that the maximum classification errors of the different datasets respectively take values that are different from each other by a predetermined value or more. Note that it is assumed that the number of iterations in a case of early stopping be common for all the pairs of datasets.

Furthermore, in the embodiment described above, a new dataset may be generated by combining two or more datasets included in the labeled dataset set. As a result, even in a case where it is difficult to prepare many datasets having different properties, the number of plot points when the index-accuracy curve is specified can be increased, and the index-accuracy curve can be accurately specified.

Furthermore, in the embodiment described above, a case has been described where the accuracy of the dataset DT for the prediction model is used as the accuracy used for the index-accuracy curve. However, the accuracy is not limited to this. For example, a value indicating a decrease degree of the accuracy for the dataset DT such as a difference between the accuracy of the dataset DS for the prediction model and the accuracy of the dataset DT for the prediction model may be used.

Furthermore, in the embodiment described above, a mode in which the accuracy estimation program is stored (installed) in the storage unit in advance is described. However, the embodiment is not limited to this. The program according to the disclosed technology may be provided in a form stored in a storage medium such as a compact disc read only memory (CD-ROM), a digital versatile disc read only memory (DVD-ROM), or a universal serial bus (USB) memory.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an accuracy estimation program for causing a computer to execute processing comprising:
acquiring, in a processor circuit of the computer, a plurality of datasets, each of which includes a plurality of pieces of data in which each data value is associated with a label, the data values having properties different for each dataset;
calculating, in the processor circuit of the computer, an index that indicates a degree of a difference between a first dataset included in the plurality of datasets and a second dataset included in the plurality of datasets by using a data value included in the second dataset;
calculating, in the processor circuit of the computer, accuracy of a prediction result for the second dataset, predicted by a prediction model trained by using the first dataset;
in response to obtaining the calculated index and the calculated accuracy, specifying, in the processor circuit of the computer, a relationship between the index and the accuracy of the prediction result by the prediction model, based on the index and the accuracy calculated for each of a plurality of combinations of the first dataset and the second dataset; and
in response to the specifying of the relationship, estimating, in the processor circuit of the computer, accuracy of the prediction result by the prediction model for a third dataset that includes a plurality of data values that are not associated with labels based on the index between the first dataset and the third dataset and the specified relationship.

2. The non-transitory computer-readable recording medium according to claim 1, wherein the index is calculated by using the prediction result by the prediction model, for the data value included in the second dataset.

3. The non-transitory computer-readable recording medium according to claim 1, wherein a plurality of classifiers that has at least different parameters is generated as a classifier in a case where the prediction model is divided into a feature extractor that extracts a feature from data and the classifier that predicts which label is associated with the data by classifying the feature extracted by the feature extractor, and a classification error that is a difference between respective prediction results of the plurality of classifiers for the second dataset or the third dataset is calculated as the index.

4. The non-transitory computer-readable recording medium according to claim 3, wherein as the index used when the relationship is specified, a value is calculated that is obtained by maximizing the classification error for the second dataset while minimizing an error of the prediction result by the prediction model for the first dataset.

5. The non-transitory computer-readable recording medium according to claim 4, wherein the number of iterations when the value obtained by maximizing the classification error is calculated by an iterative algorithm is set to a predetermined number of times so that the values obtained by maximizing the classification errors for the different second datasets are values different from each other by a predetermined value or more.

6. The non-transitory computer-readable recording medium according to claim 1, wherein, as the relationship, a regression curve that indicates a relationship between the accuracy and the index calculated for each of the plurality of combinations of the first dataset and the second dataset is specified.

7. The non-transitory computer-readable recording medium according to claim 1, wherein a new dataset is generated by combining two or more datasets included in the plurality of datasets.

8. An accuracy estimation apparatus comprising:
a memory; and
a processor circuit coupled to the memory, the processor circuit being configured to perform processing including:
acquiring a plurality of datasets, each of which includes a plurality of pieces of data in which each data value is associated with a label, the data values having properties different for each dataset;
calculating an index that indicates a degree of a difference between a first dataset included in the plurality of datasets and a second dataset included in the plurality of datasets by using a data value included in the second dataset;
calculating accuracy of a prediction result for the second dataset, predicted by a prediction model trained by using the first dataset;
in response to obtaining the calculated index and the calculated accuracy, specifying a relationship between the index and the accuracy of the prediction result by the prediction model, based on the index and the accuracy calculated for each of a plurality of combinations of the first dataset and the second dataset; and
in response to the specifying of the relationship, estimating accuracy of the prediction result by the prediction model for a third dataset that includes a plurality of data values that are not associated with labels based on the index between the first dataset and the third dataset and the specified relationship.

9. The accuracy estimation apparatus according to claim 8, wherein the index is calculated by using the prediction result by the prediction model, for the data value included in the second dataset.

10. The accuracy estimation apparatus according to claim 8, wherein a plurality of classifiers that has at least different parameters is generated as a classifier in a case where the prediction model is divided into a feature extractor that extracts a feature from data and the classifier that predicts which label is associated with the data by classifying the feature extracted by the feature extractor, and a classification error that is a difference between respective prediction results of the plurality of classifiers for the second dataset or the third dataset is calculated as the index.

11. The accuracy estimation apparatus according to claim 10, wherein as the index used when the relationship is specified, a value is calculated that is obtained by maximizing the classification error for the second dataset while minimizing an error of the prediction result by the prediction model for the first dataset.

12. The accuracy estimation apparatus according to claim 11, wherein the number of iterations when the value obtained by maximizing the classification error is calculated by an iterative algorithm is set to a predetermined number of times so that the values obtained by maximizing the classification errors for the different second datasets are values different from each other by a predetermined value or more.

13. The accuracy estimation apparatus according to claim 8, wherein, as the relationship, a regression curve that indicates a relationship between the accuracy and the index calculated for each of the plurality of combinations of the first dataset and the second dataset is specified.

14. The accuracy estimation apparatus according to claim 8, wherein a new dataset is generated by combining two or more datasets included in the plurality of datasets.

15. An accuracy estimation method implemented by a computer, the accuracy estimation method comprising:
acquiring, in a processor circuit of the computer, a plurality of datasets, each of which includes a plurality of pieces of data in which each data value is associated with a label, the data values having properties different for each dataset;
calculating, in the processor circuit of the computer, an index that indicates a degree of a difference between a first dataset included in the plurality of datasets and a second dataset included in the plurality of datasets by using a data value included in the second dataset;
calculating, in the processor circuit of the computer, accuracy of a prediction result for the second dataset, predicted by a prediction model trained by using the first dataset;
in response to obtaining the calculated index and the calculated accuracy, specifying, in the processor circuit of the computer, a relationship between the index and the accuracy of the prediction result by the prediction model, based on the index and the accuracy calculated for each of a plurality of combinations of the first dataset and the second dataset; and
in response to the specifying of the relationship, estimating, in the processor circuit of the computer, accuracy of the prediction result by the prediction model for a third dataset that includes a plurality of data values that are not associated with labels based on the index between the first dataset and the third dataset and the specified relationship.

16. The accuracy estimation method according to claim 15, wherein the index is calculated by using the prediction result by the prediction model, for the data value included in the second dataset.

17. The accuracy estimation method according to claim 15, wherein a plurality of classifiers that has at least different parameters is generated as a classifier in a case where the prediction model is divided into a feature extractor that extracts a feature from data and the classifier that predicts which label is associated with the data by classifying the feature extracted by the feature extractor, and a classification error that is a difference between respective prediction results of the plurality of classifiers for the second dataset or the third dataset is calculated as the index.

18. The accuracy estimation method according to claim 17, wherein as the index used when the relationship is specified, a value is calculated that is obtained by maximizing the classification error for the second dataset while minimizing an error of the prediction result by the prediction model for the first dataset.

19. The accuracy estimation method according to claim 18, wherein the number of iterations when the value obtained by maximizing the classification error is calculated by an iterative algorithm is set to a predetermined number of times so that the values obtained by maximizing the classification errors for the different second datasets are values different from each other by a predetermined value or more.

20. The accuracy estimation method according to claim 15, wherein, as the relationship, a regression curve that indicates a relationship between the accuracy and the index calculated for each of the plurality of combinations of the first dataset and the second dataset is specified.
